(19) United States
(12) Patent Application Publication
(10) Pub. No.: US 2025/0081018 A1
(43) Pub. Date: Mar. 6, 2025

(54) COMMUNICATION METHOD AND ELECTRONIC DEVICE

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/727,431

(22) PCT Filed: Jan. 11, 2022
(86) PCT No.: PCT/CN2022/071469

§ 371 Date: Jul. 9, 2024

(51) Int. Cl. H04W 24/10; H04W 84/12

(52) U.S. Cl. CPC H04W 24/10; H04W 84/12

(57) ABSTRACT

A communication method is provided. The method includes: transmitting an NDPA frame for acquiring a WLAN sensing channel; transmitting an NDP frame for performing a WLAN sensing measurement; transmitting a trigger frame for indicating feedback of a WLAN sensing measurement result, the trigger frame being configured to trigger delayed transmission of a feedback result and comprises information associated with the feedback; and receiving a WLAN sensing measurement result.

### CROSS-REFERENCE TO RELATED APPLICATIONS

The present application is a U.S. National Stage of International Application No. PCT/CN2022/071469 filed on Jan. 11, 2022, the entire contents of which are incorporated herein by reference for all purposes.

### TECHNICAL FIELD

The present disclosure relates to a wireless communication field, and specifically, to a communication method and a communication device.

### BACKGROUND

The wireless local area network (WLAN) has characteristic such as flexibility, mobility and low cost. With the development of communication technology and the growth of user needs, the research on WLAN applications is gradually increased. For example, WLAN sensing is currently being investigated, which main applications are location discovery in dense environments (home and corporate environments), proximity detection, presence detection or the like.

### SUMMARY

Various embodiments of the present disclosure provide the following technical solutions.

An embodiment of the present disclosure provides a communication method. The communication method may include: transmitting an NDPA frame for acquiring a WLAN sensing channel; transmitting an NDP frame for performing a WLAN sensing measurement; transmitting a trigger frame for indicating feedback of a WLAN sensing measurement result, wherein the trigger frame is configured to trigger delayed transmission of a feedback result and includes information associated with the feedback; and receiving a WLAN sensing measurement result.

An embodiment of the present disclosure provides a communication method. The communication method may include: receiving an NDPA frame for acquiring a WLAN sensing channel; receiving an NDP frame for performing a WLAN sensing measurement; receiving a trigger frame for indicating feedback of a WLAN sensing measurement result, wherein the trigger frame is configured to trigger delayed transmission of a feedback result and includes information associated with the feedback; and transmitting a WLAN sensing measurement result.

An embodiment of the present disclosure provides a communication device. The communication device may include a transceiver module configured to: transmit an NDPA frame for acquiring a WLAN sensing channel; transmit an NDP frame for performing a WLAN sensing measurement; transmit a trigger frame for indicating feedback of a WLAN sensing measurement result, wherein the trigger frame is configured to trigger delayed transmission of a feedback result and includes information associated with the feedback; and receive a WLAN sensing measurement result.

An embodiment of the present disclosure provides a communication device. The communication device may include a transceiver module configured to: receive an NDPA frame for acquiring a WLAN sensing channel; receive an NDP frame for performing a WLAN sensing measurement; receive a trigger frame for indicating feedback of a WLAN sensing measurement result, wherein the trigger frame is configured to trigger delayed transmission of a feedback result and includes information associated with the feedback; and transmit a WLAN sensing measurement result.

An embodiment of the present disclosure provides an electronic device. The electronic device may include a memory, a processor and a computer program stored on the memory and runnable on the processor. The processor, when executing the computer program, implements the above method.

An embodiment of the present disclosure provides a computer-readable storage medium. The computer-readable storage medium has stored thereon a computer program. The computer program, when being executed by a processor, implements the above method.

### BRIEF DESCRIPTION OF THE DRAWINGS

These and other features of embodiments of the present disclosure will become more apparent by describing in detail embodiments of the present disclosure with reference to the accompanying drawings, in which:

FIG. 1 illustrates a manner of WLAN sensing;

FIG. 2 is a flowchart of a communication method performed by an initiator under delayed feedback according to an example embodiment;

FIG. 3 is an interaction process between an initiator and a responder under delayed feedback according to an example embodiment;

FIG. 4 is a flowchart of a communication method performed by an initiator under immediate feedback according to an example embodiment;

FIG. 5 is an interaction process between an initiator and a responder under immediate feedback according to an example embodiment;

FIG. 6 is a flowchart of a communication method performed by a responder under delayed feedback according to an example embodiment;

FIG. 7 is a flowchart of a communication method performed by a responder under immediate feedback according to an example embodiment; and

FIG. 8 is a block diagram of a communication device according to an example embodiment.

### DETAILED DESCRIPTION

Various embodiments of the present disclosure are described below with reference to the accompanying drawings. The various embodiments of the present disclosure include various specific details, but these specific details are considered exemplary only. In addition, descriptions of well-known techniques, functions, and constructions may be omitted for clarity and brevity.

Terms and phrases used in the present disclosure are not limited to their written meaning, but are used only by the inventors to enable a clear and consistent understanding of the present disclosure. Accordingly, for a person skilled in the art, the description of various embodiments of the present disclosure is provided for illustrative purposes only and is not intended to be limiting.

It shall be understood that the singular forms “a”, “an”, “said” and “the” as used herein may also include a plural form unless clearly indicated otherwise in the context. It shall be further understood that the term “including/comprising” as used in the present disclosure refers to the presence of the described feature, integer, step, operation, element and/or component, but does not preclude the presence or addition of one or more other features, integers, steps, operations, elements, components and/or groups thereof.

It is to be understood that although the terms “first”, “second”, etc. may be used herein to describe various elements, these elements should not be limited by these terms. These terms are only used to distinguish one element from another. Thus, without departing from the teachings of the example embodiments, a first element discussed below may be referred to as a second element.

It shall be understood that when an element is referred to as “connected” or “coupled” to an other element, it may be directly connected or coupled to the other element, or there may be an intermediate element therebetween. In addition, the “connect” or “couple” as used herein may include wirelessly “connect” or “couple”. The term “and/or” or the expression “at least one of . . . ” as used herein include any and all combinations of one or more of the relevant listed items.

Unless otherwise defined, all terms used herein (including technical and scientific terms) have the same meaning as generally understood by a person skilled in the art to which the present disclosure belongs.

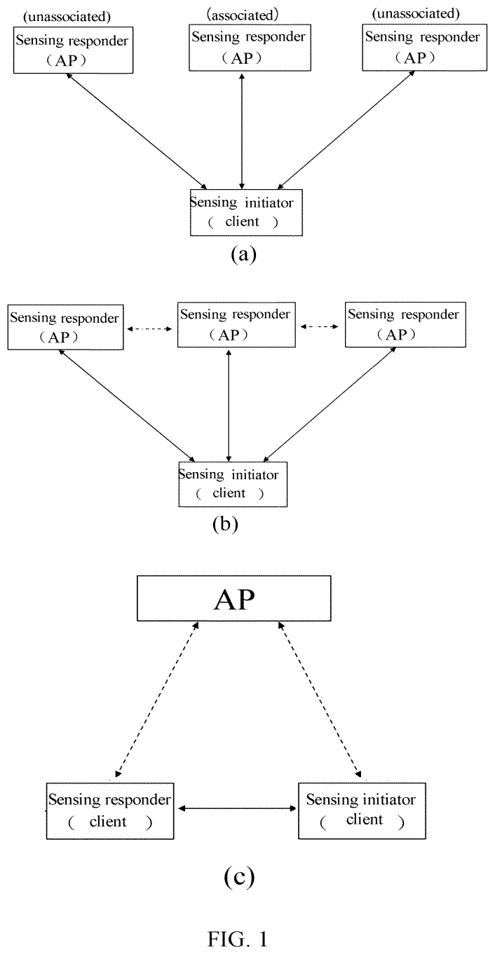

FIG. 1 illustrates a manner of WLAN sensing.

The process of WLAN sensing may be as follows: an initiator initiates WLAN sensing (e.g., initiates a WLAN sensing session), there may be a plurality of responders responding thereto, and the specific possible manners may be as illustrated in (a), (b), and (c) of FIG. 1.

Referring to (a) in FIG. 1, when a WLAN sensing initiator (e.g., a client) initiates WLAN sensing, a plurality of associated or unassociated WLAN sensing responders (e.g., three access points) may respond thereto. The “associated” may mean that the initiator and the responder have established an association connection therebetween, and the “unassociated” may mean that the initiator and the responder have not established an association connection therebetween.

As an example, the client may include, but is not limited to: a cellular phone, a smart phone, a wearable device, a computer, a personal digital assistant (PDA), a personal communication system (PCS) device, a personal information manager (PIM), a personal navigation device (PND), a global positioning system (GPS), a multimedia device, an Internet of Things (IoT) device, and the like.

The AP may be a wireless switch for a wireless network or an access device for a wireless network. The AP may include a software application and/or circuitry to enable other types of nodes in the wireless network to communicate with an element outside and inside the wireless network through the AP. As an example, the AP may be a terminal device or network device equipped with a Wi-Fi (wireless fidelity) chip.

The (b) in FIG. 1 is similar to (a) in FIG. 1, but in (b) of FIG. 1, the communication may be conducted between individual responders (APs).

Referring to (c) in FIG. 1, both the WLAN sensing initiator and the WLAN sensing responder may be clients, and both may communicate by connecting to the same AP.

Although it is illustrated in (a), (b), and (c) of FIG. 1 that the client serves as the initiator and the AP serves as the responder, however the present disclosure is not limited thereto, e.g., the AP may serve as the initiator and the client may serve as the responder. Further, the number of initiators and responders is not limited to that shown in (a), (b), and (c) of FIG. 1.

As an illustrative embodiment, the WLAN sensing process may include: a WLAN sensing session setup, a WLAN sensing measurement setup, a WLAN sensing measurement, a WLAN sensing measurement feedback, and a WLAN sensing measurement termination. In the WLAN sensing session setup, operation parameters associated with the sensing session may be determined and may be exchanged between devices. In the WLAN sensing measurement setup, one or more WLAN sensing measurements may be set up. In the WLAN sensing measurement, the initiator and the responder may perform the WLAN sensing measurement, and one WLAN sensing measurement may include one or more WLAN sensing measurement exchanges. In the WLAN sensing measurement feedback, the responder may feed back (report) the WLAN sensing measurement result to the initiator. In the WLAN sensing measurement termination, the initiator and the responder may stop the WLAN sensing measurement and terminate the sensing session.

In addition, in the WLAN sensing technique, a trigger-based (TB-based) sensing manner and a non-trigger-based (non-TB based) sensing manner are proposed. For example, in the TB-based sensing manner, the AP may be the initiator or transmitter, and in the non-TB based sensing manner, a station (STA) may be the initiator or transmitter. The example of the station (STA) may be similar to that of the client above, and the repetitive description thereof is omitted here for brevity.

For the WLAN sensing measurement feedback, the measurement result in a sensing session should be available to the initiator or reported to the initiator. For example, the WLAN sensing measurement feedback may be performed by transmitting a sensing measurement report frame, and the transmission of the frame may be initiated by an MLME (MAC sublayer management entity) primitive. In addition, the WLAN sensing measurement feedback may be in the type of immediate reporting or delayed reporting. In the following, the immediate reporting may also be referred to as immediate feedback, and the delayed reporting may also be referred to as delayed feedback. In the immediate reporting type, the sensing measurement are fed back immediately whenever a sensing measurement exchange is executed, and in the delayed reporting type, the sensing measurement result may be fed back after a plurality of sensing measurement exchanges have been executed.

As mentioned above, in the TB-based sensing manner, the AP may act as the initiator to initiate the downlink sensing, i.e., transmit an NDPA (null data packet announcement) frame and an NDP (null data packet) frame, and the STA may act as the responder to provide the sensing measurement feedback, and the feedback may be in an immediate or delayed type. However, in the current study, a mechanism as how to implement the feedback (e.g., immediate reporting or delayed reporting) is not complete.

In view of this, a communication method and a communication device according to an embodiment of the present disclosure are provided.

FIG. 2 is a flowchart of a communication method according to an example embodiment. The communication method shown in FIG. 2 may be applied to a WLAN sensing initiator (AP).

Referring to FIG. 2, in step 210, an NDPA frame for acquiring a WLAN sensing channel is transmitted. According to an embodiment of the present disclosure, the NDPA frame may carry various information about WLAN sensing. For example, the NDPA frame may include a WLAN sensing measurement setup identifier, information for indicating a feedback type (immediate feedback or delayed feedback), and the like. However, the present disclosure is not limited thereto, for example, the NDPA frame may also include a WLAN sensing session setup identifier and the like.

In step 220, an NDP frame for performing a WLAN sensing measurement is transmitted. In an embodiment of the present disclosure, the NDP frame may be a WLAN sensing frame, in other words, the responder (STA), upon receiving the NDP frame from the initiator (AP), may perform a WLAN sensing measurement using or based on the NDP frame.

In step 230, a trigger frame for indicating feedback of a WLAN sensing measurement result is transmitted. In an embodiment of the present disclosure, the trigger frame may correspond to delayed feedback and may trigger delayed feedback of the measurement result.

In step 240, the WLAN sensing measurement result is received. For example, after transmitting the trigger frame for triggering the feedback in step 230, the responder may transmit the WLAN sensing measurement result to the initiator based on the information about the feedback carried in the trigger frame. The information carried in the trigger frame in step 230 is described in detail below.

According to an embodiment of the present disclosure, the trigger frame may include information associated with the feedback. For example, the trigger frame may include at least one of:
a WLAN sensing session identifier;
a WLAN sensing measurement setup identifier;
a WLAN sensing measurement exchange identifier;
a type identifier identifying the trigger frame as a delayed measurement result feedback trigger frame;
a station identifier of a station participating in a WLAN sensing measurement exchange;
a resource unit for feeding back the WLAN sensing measurement result;
a bandwidth used by a frame feeding back the WLAN sensing measurement result; or
a receiver address.

According to an embodiment of the present disclosure, the WLAN sensing measurement setup identifier included in the trigger frame may be the same as the WLAN sensing measurement setup identifier included in the NDPA frame described above. In this way, the delayed feedback triggered by the trigger frame may be identified as corresponding to the NDPA frame to ensure that the feedback is correct.

The trigger frame according to an embodiment of the present disclosure may have various forms. For example, as a non-limiting embodiment, the trigger frame transmitted in step 230 may be a BFRP (beamforming report poll) trigger frame. The included information described above may be carried separately in various information fields of the trigger frame, in other words, the trigger frame may include: a first information field (e.g., a common information (info) field) associated with the WLAN sensing measurement, a second information field (e.g., a station information (STA info) field) associated with the station, a third information field (e.g., a control field) associated with control information, and/or other information fields (e.g., a receiver address (RA) or the like).

For example, in the first information field (e.g., the common info field) of the trigger frame, it may include: the WLAN sensing session identifier, the WLAN sensing measurement setup identifier, the WLAN sensing measurement exchange identifier, the type identifier, and the like. For example, the first information field (e.g., the common info field) of the trigger frame may have a format as shown in Table 1 below, which however is not limited thereto.

TABLE 1

sensing session ID1
measurement setup ID1
sensing measurement exchange ID11
sensing measurement exchange ID12
. . .
sensing session ID2
measurement setup ID2
sensing measurement exchange ID21
sensing measurement exchange ID22
. . .
TYPE

One WLAN sensing session setup process may initiate one or more WLAN sensing measurement setups. For example, the trigger frame may include one or more WLAN sensing session identifiers (e.g., sensing session ID1, sensing session ID2, etc., in Table 1) to identify the one or more WLAN sensing session setups, and each WLAN sensing session identifier may correspond to one or more WLAN sensing measurement setup identifiers (e.g., measurement setup ID1, measurement setup ID2, etc., in Table 1). One WLAN sensing measurement setup process may initiate one or more WLAN sensing measurement exchanges. For example, the trigger frame may include one or more WLAN sensing measurement setup identifiers to identify the one or more WLAN sensing measurement setup processes, and each WLAN sensing measurement setup identifier may correspond to one or more WLAN sensing measurement exchange identifiers (e.g., sensing measurement exchange ID11, sensing measurement exchange ID12, sensing measurement exchange ID21, sensing measurement exchange ID22, etc., in Table 1).

Further, in the first information field (e.g., the common info field) of Table 1, it may further include the type identifier (TYPE) to identify the trigger frame (e.g., a BFRP trigger frame) as a delayed measurement result feedback trigger frame.

It is to be understood that the above information included in the first information field (e.g., the common info field) of the trigger frame in Table 1 is only exemplary, and the present disclosure is not limited thereto, for example, some of the information in Table 1 may be omitted. For example, the WLAN sensing session identifier may be omitted when the trigger frame only indicates delayed feedback for a sensing measurement in one WLAN sensing session, and the WLAN sensing measurement setup identifier may be omitted when the trigger frame only indicates delayed feedback for a sensing measurement exchange in one WLAN sensing measurement setup phase.

Furthermore, the format of the first information field (e.g., the common info field) shown in Table 1 is only exemplary and the present disclosure is not limited thereto, e.g., Table 1 may be split into a plurality of first information fields (e.g., the common info field), i.e., the first information field (e.g., the common info field) may be repeated for identifying different WLAN sensing session identifiers and/or WLAN sensing measurement setup identifiers.

For example, the trigger frame may include one or more second information fields (e.g., STA info fields), and each second information field (e.g., STA info field) may include a station identifier and a resource unit (RU). The second information field (e.g., STA info field) may include identifiers of one or more stations performing the WLAN sensing measurement (i.e., one or more station identifiers). Each station identifier may be represented as an AID or a UID. The AID may indicate that the station identified by the identifier has established an associative connection with the AP, e.g., the AID may have been assigned during the STA establishing an association with the AP. The UID may indicate that the station identified by the identifier has not established an associative connection with the AP, e.g., the UID may have been assigned during the AP performing the WLAN sensing measurement setup with the STA. The resource unit (RU) in the second information field (e.g., the STA info field) may correspond to the station identifier to identify the resource unit (RU) used by the corresponding station when feeding back the measurement result. For example, the resource unit (RU) may represent a subcarrier (tone) of a different size or type, such as 26-tone, 52-tone, 106-tone, and the like.

As described above, the station identifier and the resource unit may be included in the STA info field of the trigger frame. According to an embodiment of the present disclosure, the receiver address in the trigger frame may correspond to the second information field (STA info field). In an embodiment of the present disclosure, in the case that the trigger frame includes one STA info field, the receiver address may be a MAC address of the station. In this case, the access point and the station may be devices that satisfy an extremely high throughput (EHT) communication standard, and the access point and the station may communicate under a plurality of links, and the receiver address may be a MAC address of the station under a corresponding link. In another embodiment of the present disclosure, in the case that the trigger frame includes a plurality of STA info fields, the receiver address may be a broadcast address. That is, in the case that the trigger frame triggers a plurality of stations to provide delayed feedback, the trigger frame may be transmitted in a broadcast manner. However, the present disclosure is not limited to this, and the receiver address may also be a multicast address.

For example, the third information field (e.g., the control field) of the trigger frame may include the bandwidth used by a frame feeding back the WLAN sensing measurement result. For example, the third information field (e.g., the control field) may include a UL BW field to identify an uplink bandwidth in which the responder transmits the frame that feeds back the measurement result. According to an embodiment of the present disclosure, this bandwidth may be, for example, but not limited to, 20 MHz, 40 MHz, 80 MHz, 160 MHz, 80+80 MHz, 320 MHz, or 160+160 MHz. In an embodiment of the present disclosure, this bandwidth may be different from the bandwidth used to transmit the NDP frame in step 220. Specifically, the frame that feeds back the WLAN sensing measurement result may include more complex information than the NDP frame, and thus the bandwidth used for the frame that feeds back the WLAN sensing measurement result may be greater than the bandwidth used for transmitting the NDP frame. However, the present disclosure is not limited to this, and the two bandwidths may also be the same.

It is to be understood that the information included in the trigger frame described in the above embodiments is only exemplary, and the present disclosure is not limited thereto. The trigger frame may also include other information such as a transmitter address (TA), or some of the information described in the above embodiments may be omitted from the trigger frame.

According to an embodiment of the present disclosure, a BFRP trigger frame may be transmitted at a delayed feedback time point for triggering the responder to transmit a delayed feedback measurement result. The trigger frame includes at least:
a common info field, wherein the common info field includes information of a WLAN sensing measurement setup ID, which has the same value as the ID in the previously transmitted NDPA frame, and it further includes a WLAN sensing measurement exchange ID corresponding to the WLAN sensing measurement setup ID, wherein the common info field may be repeated to identify different WLAN sensing measurement setup IDs;
a STA info field, wherein the STA info field may include an identification of the STA (e.g., AID/UID), and RU/MRU corresponding thereto, wherein the RU/MRU may be used for the STA to transmit a delayed feedback measurement result; and
a control domain, wherein the control domain may include a UL BW field, which is used to identify the uplink bandwidth of the frame in which the STA transmits the feedback measurement result, e.g., three bits may be used to identify the bandwidth, specifically, the uplink bandwidths of 20/40/80/160(80+80)/320(160+160) MHz, respectively, and additionally the bandwidth of the measurement result feedback frame may be different from the bandwidth with which the initiator transmits the NDP frame.

Furthermore, in the BFRP trigger frame, the common info filed may further include a type of BFRP frame, which is used to identify the trigger frame as a delayed measurement result feedback trigger frame.

In addition, if the trigger frame includes only one STA info field, the RA address may be a MAC address of the STA/a MAC address under the corresponding connection (in case that the device satisfies the EHT communication standard); and if the trigger frame includes a plurality of STA info fields, the RA address may be a broadcast address.

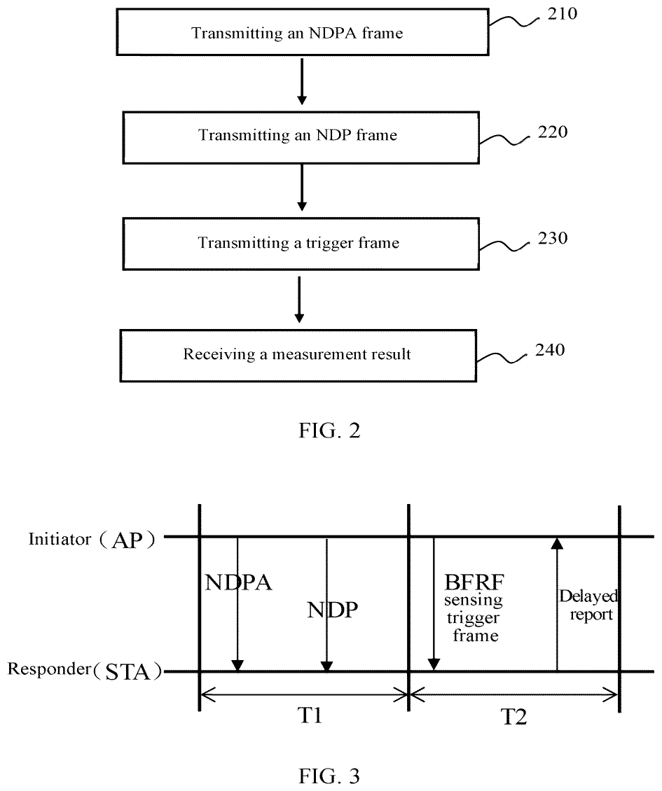

According to the embodiment described above, the flowchart shown in FIG. 2 may correspond to the delayed feedback type, for example, the interaction process between the initiator and the responder in the delayed feedback type may be shown in FIG. 3. Referring to FIG. 3, steps 210 and 220 of FIG. 2 may be performed in time period T1, and steps 230 and 240 of FIG. 2 may be performed in time period T2. It is to be appreciated, however, that the flowchart and the interaction process shown in FIGS. 2 and 3 are only exemplary, and the present disclosure is not limited thereto. For example, in the time period T1 of FIG. 3, a plurality of NDP frames may be transmitted for a plurality of WLAN sensing measurements; and in the time period T2, the trigger frame may trigger feedback of the plurality of WLAN sensing measurements, and in a delayed report, the initiator may receive the results of the plurality of WLAN sensing measurements (e.g., CSI (channel state information)).

In an embodiment of the present disclosure, labelling with respect to the feedback type (e.g., the delayed feedback of FIG. 2) may be implemented in different ways.

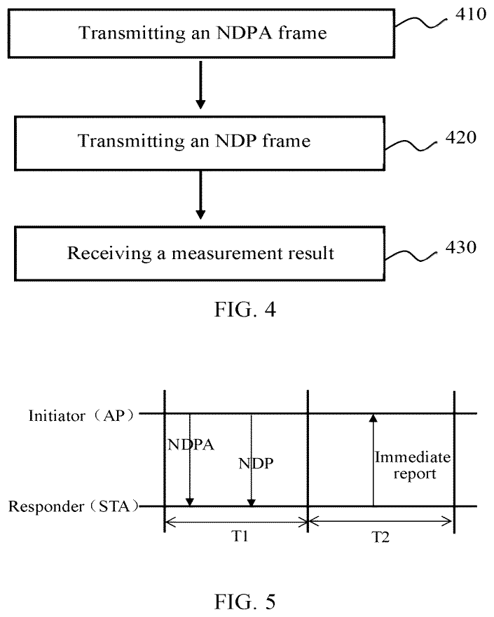

According to an embodiment of the present disclosure, the NDPA frame may include an identification bit identifying the type in which the WLAN sensing measurement result is fed back. For example, one bit in the common info field of the NDPA frame may be used to identify the feedback type. When the bit is set to be “0”, it identifies immediate feedback of the measurement result (e.g., the communication method shown in FIGS. 4 and 5, which will be described below, may be performed); and when the bit is set to be “1”, it identifies delayed feedback of the measurement result (e.g., the communication method shown in FIGS. 2 and 3 described above may be performed). According to one aspect of the present disclosure, the identification bit may be configured to identify a delayed feedback type so that the embodiments of FIGS. 2 and 3 may be implemented.

According to another embodiment of the present disclosure, the feedback type of the WLAN sensing measurement result may be determined during the WLAN sensing measurement setup process. For example, the feedback type may be determined prior to performing the methods shown in FIGS. 2 and 3, specifically, the feedback type (feedback manner) may be negotiated between the initiator and the responder during the WLAN sensing measurement setup process, and information regarding the feedback type is generally carried in a measurement setup request frame and a measurement setup response frame. According to one aspect of the present disclosure, the determined type may be delayed feedback, so that the embodiments of FIGS. 2 and 3 may be implemented.

According to other aspects of the present disclosure, the identification bit in the NDPA frame may be configured to identify immediate feedback, or the feedback type determined during the WLAN sensing measurement setup process may be immediate feedback. In this case, the step of transmitting the trigger frame in FIGS. 2 and 3 may be omitted, and the WLAN sensing measurement result may be received directly. In other words, in the case of immediate feedback, the flowchart shown in FIG. 4 and the interaction process shown in FIG. 5 may be performed. In FIG. 4 and FIG. 5, the identification bit for identifying immediate feedback may be set in the NDPA frame transmitted in step 410, or the immediate feedback type may be determined during the WLAN sensing measurement setup process performed prior to step 410. The NDP frame may be transmitted in step 420, and since the immediate feedback is used, the NDP frame may be transmitted only once in the time period T1 of FIG. 5. The WLAN sensing measurement result (i.e., the immediate report) may be received directly in step 430.

The communication method according to the embodiment of the present disclosure improves the delayed feedback method and/or the immediate feedback method in TB-based sensing, which thus can meet the WLAN sensing needs.

FIG. 6 is a flowchart of a communication method performed by a responder under delayed feedback according to an example embodiment. That is, the communication method shown in FIG. 6 may be applied to a responder (station).

Referring to FIG. 6, in step 610, an NDPA frame for acquiring a WLAN sensing channel is received; in step 620, an NDP frame for performing a WLAN sensing measurement is received; in step 630, a trigger frame for indicating feedback of a WLAN sensing measurement result is received, wherein the trigger frame is configured to trigger delayed transmission of a feedback result and includes information associated with the feedback; and in step 640, a WLAN sensing measurement result is transmitted. It is to be understood that the embodiment shown in FIG. 6 is not limited thereto, for example, the communication method of FIG. 6 may also include performing a sensing measurement using a received NDP frame and transmitting a delayed feedback measurement result upon receipt of the trigger frame.

According to an embodiment of the present disclosure, the trigger frame may include at least one of:
a WLAN sensing session identifier;
a WLAN sensing measurement setup identifier;
a WLAN sensing measurement exchange identifier;
a type identifier identifying the trigger frame as a delayed measurement result feedback trigger frame;
a station identifier of a station participating in a WLAN sensing measurement exchange;
a resource unit for feeding back the WLAN sensing measurement result;
a bandwidth used by a frame feeding back the WLAN sensing measurement result; or
a receiver address.

According to an embodiment of the present disclosure, the NDPA frame may include a WLAN sensing measurement setup identifier, and the WLAN sensing measurement setup identifier included in the trigger frame may be the same as the WLAN sensing measurement setup identifier included in the NDPA frame.

According to an embodiment of the present disclosure, the above bandwidth may be 20 MHz, 40 MHz, 80 MHz, 160 MHz, 80+80 MHz, 320 MHz, or 160+160 MHz.

According to an embodiment of the present disclosure, the bandwidth used by the frame feeding back the WLAN sensing measurement result (i.e., the bandwidth used in step 640) may be different from the bandwidth used for receiving the NDP frame (i.e., the bandwidth used in step 620).

According to an embodiment of the present disclosure, the station identifier and resource unit may be included in the STA info field of the trigger frame.

According to an embodiment of the present disclosure, in the case that the trigger frame includes one station information field, the receiver address may be a MAC address of the station; and in the case that the trigger frame includes a plurality of station information fields, the receiver address may be a broadcast address.

The embodiments described above with respect to the trigger frame may be applied to FIG. 6, and repeated descriptions thereof are omitted herein for brevity.

According to an embodiment of the present disclosure, the NDPA frame may include an identification bit identifying a feedback type of the WLAN sensing measurement result, for example, the identification bit may be configured to identify a delayed feedback type so as to perform the communication method shown in FIG. 6.

According to an embodiment of the present disclosure, the feedback type of the WLAN sensing measurement result may be determined during the WLAN sensing measurement setup process, e.g., the determined type is delayed feedback, so that the communication method shown in FIG. 6 is performed.

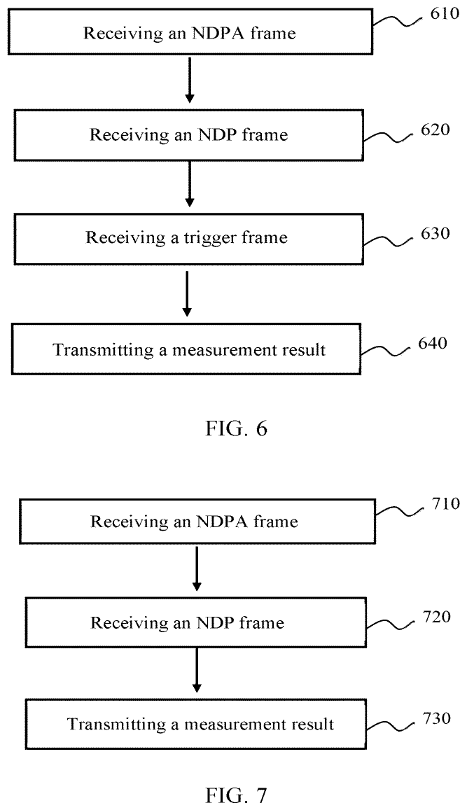

According to an embodiment of the present disclosure, the above identification bit in the NDPA frame may be configured to identify immediate feedback, or the above-determined type may be immediate feedback, in which case the step of receiving the trigger frame in FIG. 6 is omitted and the WLAN sensing measurement result is directly transmitted, i.e., the communication method shown in FIG. 7 may be executed. In FIG. 7, the NDP frame (which may carry an identification bit identifying the immediate feedback) may be transmitted in step 710, and upon receiving the NDP frame (step 720), the responder may perform the WLAN sensing measurement, and upon obtaining the WLAN sensing measurement result, immediately feed back the result to the initiator (step 730).

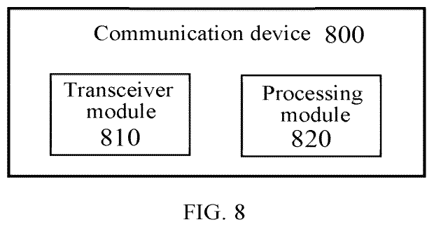

FIG. 8 is a block diagram illustrating a communication device according to an example embodiment. The communication device 800 of FIG. 8 may include a processing module 810 and a transceiver module 820. In an embodiment of the present disclosure, the communication device 800 shown in FIG. 8 may be applied to an initiator (AP); and in another embodiment of the present disclosure, the communication device 800 shown in FIG. 8 may be applied to a responder (STA).

In the case that the communication device 800 shown in FIG. 8 may be applied to the initiator (AP), the processing module 810 may be configured to: control the overall operation of the communication device 800 (e.g., controlling the determination and transmission of an NDPA frame, an NDP frame, and a trigger frame, etc.); and the transceiver module 820 may be configured to: transmit an NDPA frame for acquiring a WLAN sensing channel; transmit an NDP frame for performing a WLAN sensing measurement; transmit a trigger frame for indicating feedback of a WLAN sensing measurement result, wherein the trigger frame is configured to trigger delayed transmission of a feedback result and includes information associated with the feedback; and receive a WLAN sensing measurement result. That is, the communication device 800 shown in FIG. 8 may perform the communication method described with reference to FIGS. 2 to 5, and the embodiments described above with respect to the trigger frame may be applied thereto, and repetitive descriptions thereof are omitted herein to avoid redundancy.

In the case that the communication device 800 shown in FIG. 8 may be applied to the responder (STA), the transceiver module 820 may be configured to: control the overall operation of the communication device 800 (e.g., controlling the reception of an NDPA frame, an NDP frame, and a trigger frame, controlling the execution of a WLAN sensing measurement, controlling the feedback of a WLAN sensing measurement result, etc.); and the processing module 810 may be configured to: receive an NDPA frame for acquiring a WLAN sensing channel; receive an NDP frame for performing a WLAN sensing measurement; receive a trigger frame for indicating feedback of a WLAN sensing measurement result, wherein the trigger frame is configured to trigger delayed transmission of a feedback result and includes information associated with the feedback; and transmit a WLAN sensing measurement result. That is, the communication device 800 shown in FIG. 8 may perform the communication method described with reference to FIGS. 6 and 7, and the embodiments described above with respect to the trigger frame may be applied thereto, and repetitive descriptions thereof are omitted herein to avoid redundancy.

It is to be understood that the communication device 800 shown in FIG. 8 is only exemplary and the embodiments of the present disclosure are not limited thereto, for example, the communication device 800 may also include other modules, such as a memory module and the like. In addition, individual modules in the communication device 800 may be combined into a more complex module or may be divided into more separate modules.

The communication method and the communication device according to embodiments of the present disclosure improve the feedback method (e.g., the delayed feedback method and/or the immediate feedback method) in WLAN sensing, which thus can meet the WLAN sensing needs.

Based on the same principle as the method provided in the embodiment of the present disclosure, an embodiment of the present disclosure also provides an electronic device including a processor and a memory. The memory stores machine-readable instructions (which may also be referred to as a “computer program”), and the processor is configured to execute the machine-readable instructions to implement the method described with reference to FIGS. 2 to 7.

An embodiment of the present disclosure also provides a computer-readable storage medium having a computer program stored thereon. The computer program, when being executed by a processor, implements the method described with reference to FIGS. 2 to 7.

In an example embodiment, the processor may be a logic box, module, and circuitry for implementing or executing various embodiments described in conjunction with the present disclosure, for example, a CPU (central processing unit), a general purpose processor, a DSP (digital signal processor), an ASIC (application specific integrated circuit), an FPGA (field programmable gate array) or other programmable logic devices, a transistor logic device, a hardware component, or any combination thereof. The processor may also be a combination that implements computing functions, such as a combination including one or more microprocessors, a combination of a DSP and a microprocessor, and the like.

In an example embodiment, the memory may be, for example, ROM (read only memory), RAM (random access memory), EEPROM (electrically erasable programmable read only memory), CD-ROM (compact disc read only memory) or other optical disc memory, optical disc storage (including compact disc, laser disc, optical disc, digital versatile disc, blue-ray Disc, etc.), magnetic storage media, or other magnetic storage devices, or devices that can be used to carry or store program code in the form of instructions or data structures and can be accessed by a computer, which however is not limited thereto.

It shall be understood that although the steps in the flowchart of the accompanying drawings are shown sequentially as indicated by the arrows, the steps are not necessarily executed sequentially in the order indicated by the arrows. Unless expressly stated herein, the execution of these steps is not strictly limited in order, and they may be executed in other orders. In addition, at least some of the steps in the flowchart of the accompanying drawings may include a plurality of sub-steps or a plurality of phases, which sub-steps or phases are not necessarily executed or completed at the same time point but may be executed at different time points, and the execution order thereof is not necessarily sequential, but may be alternate with that of other steps or some sub-steps or phases of the other steps.

Although the present disclosure has been shown and described with reference to certain embodiments of the present disclosure, a person skilled in the art will appreciate that various changes in form and detail may be made without departing from the scope of the present disclosure. Accordingly, the scope of the present disclosure should not be limited to being limited by the embodiments, but rather by the appended claims and their equivalents.

1. A communication method comprising:
transmitting a null data packet announcement (NDPA) frame for acquiring a WLAN sensing channel;
transmitting a null data packet (NDP) frame for performing a WLAN sensing measurement;
transmitting a trigger frame for indicating feedback of a WLAN sensing measurement result, wherein the trigger frame is configured to trigger delayed transmission of a feedback result and comprises information associated with the feedback; and
receiving a WLAN sensing measurement result.

2. The communication method according to claim 1, wherein the trigger frame comprises at least one of:
a WLAN sensing session identifier;
a WLAN sensing measurement setup identifier;
a WLAN sensing measurement exchange identifier;
a type identifier identifying the trigger frame as a delayed measurement result feedback trigger frame;
a station identifier of a station participating in a WLAN sensing measurement exchange;
a resource unit for feeding back the WLAN sensing measurement result;
a bandwidth used by a frame feeding back the WLAN sensing measurement result; or
a receiver address.

3. The communication method according to claim 2, wherein the NDPA frame comprises a WLAN sensing measurement setup identifier, and
wherein the WLAN sensing measurement setup identifier comprised in the trigger frame is the same as the WLAN sensing measurement setup identifier comprised in the NDPA frame.

4. (canceled)

5. The communication method according to claim 4, wherein the bandwidth is different from a bandwidth for transmitting the NDP frame.

6. The communication method according to claim 2, wherein the station identifier and the resource unit are comprised in a station information field of the trigger frame.

7. The communication method according to claim 6, wherein in the case that the trigger frame comprises one station information field, the receiver address is a MAC address of the station, and
wherein in the case that the trigger frame comprises a plurality of station information fields, the receiver address is a broadcast address.

8. The communication method according to claim 1, wherein the NDPA frame comprises an identifier that specifies a feedback type of the WLAN sensing measurement result, and
wherein the identifier is configured to identify the feedback type as delayed feedback-type.

9. The communication method according to claim 1, further comprising:
determining a feedback type of the WLAN sensing measurement result during a WLAN sensing measurement setup,
wherein the feedback type is determined as delayed feedback.

10. The communication method according to claim 8, wherein the identifier is configured to indicate immediate feedback or the feedback type is determined as the immediate feedback, and the communication method further comprises:
directly receiving the WLAN sensing measurement result without transmitting the trigger frame.

11. A communication method comprising:
receiving a null data packet announcement (NDPA) frame for acquiring a WLAN sensing channel;
receiving a null data packet (NDP) frame for performing a WLAN sensing measurement;
receiving a trigger frame for indicating feedback of a WLAN sensing measurement result, wherein the trigger frame is configured to trigger delayed transmission of a feedback result and comprises information associated with the feedback; and
transmitting a WLAN sensing measurement result.

12. The communication method according to claim 11, wherein the trigger frame comprises at least one of:
a WLAN sensing session identifier;
a WLAN sensing measurement setup identifier;
a WLAN sensing measurement exchange identifier;
a type identifier identifying the trigger frame as a delayed measurement result feedback trigger frame;
a station identifier of a station participating in a WLAN sensing measurement exchange;
a resource unit for feeding back the WLAN sensing measurement result;
a bandwidth used by a frame feeding back the WLAN sensing measurement result; or
a receiver address.

13. The communication method according to claim 12, wherein the NDPA frame comprises a WLAN sensing measurement setup identifier, and
wherein the WLAN sensing measurement setup identifier comprised in the trigger frame is the same as the WLAN sensing measurement setup identifier comprised in the NDPA frame.

14. (canceled)

15. The communication method according to claim 14, wherein the bandwidth is different from a bandwidth for receiving the NDP frame.

16. The communication method according to claim 12, wherein the station identifier and the resource unit are comprised in a station information field of the trigger frame.

17. The communication method according to claim 16, wherein in the case that the trigger frame comprises one station information field, the receiver address is a MAC address of the station, and
wherein in the case that the trigger frame comprises a plurality of station information fields, the receiver address is a broadcast address.

18. The communication method according to claim 11, wherein the NDPA frame comprises an identifier that specifies a feedback type of the WLAN sensing measurement result, and
wherein the identifier is configured to identify the feedback type as delayed feedback.

19. The communication method according to claim 11, further comprising:
determining a feedback type of the WLAN sensing measurement result during a WLAN sensing measurement setup,
wherein the feedback type is determined as delayed feedback.

20. The communication method according to claim 18, wherein the identifier is configured to indicate immediate feedback or the feedback type is determined as the immediate feedback, and the communication method further comprises:
directly transmitting the WLAN sensing measurement result without receiving the trigger frame.

21-22. (canceled)

23. An electronic device comprising:
a processor; and
a memory storing instructions executable by the processor,
wherein the processor is configured to:
transmit a null data packet announcement (NDPA) frame for acquiring a WLAN sensing channel;
transmit a null data packet (NDP) frame for performing a WLAN sensing measurement;
transmit a trigger frame for indicating feedback of a WLAN sensing measurement result, wherein the trigger frame is configured to trigger delayed transmission of a feedback result and comprises information associated with the feedback; and
receive a WLAN sensing measurement result.

24. (canceled)

25. An electronic device comprising
a processor; and
a memory storing instructions executable by the processor,
wherein the processor is configured to execute the communication method according to claim 11.
